(19) United States
(12) Patent Application Publication
(10) Pub. No.: US 2004/0081179 A1
(43) Pub. Date: Apr. 29, 2004

(54) Method and system for selecting between serial storage buses using data signals of the buses

(76) Inventor: Arthur J. Gregorcyk JR., Austin, TX (US)

Correspondence Address: HAMILTON & TERRILE, LLP, P.O. BOX 203518, AUSTIN, TX, 78720, US

(21) Appl. No.: 10/279,484

(22) Filed: Oct. 23, 2002

(51) Int. Cl. H04L 12/28

(52) U.S. Cl. 370/402

(57) ABSTRACT

A method and system for selecting one of plural storage buses to communicate with a storage information handling system having a single storage data port uses data storage signals of the buses to switch a multiplexing device that selects a bus that is sending a valid data storage signal. A bus selector interfaces a multiplexing device with the single port and interfaces first and second buses with the multiplexing device. A signal detector monitors the first and second buses to detect data storage signals, such as an establish port command, associated with a bus and directs the multiplexing device to enable an interface of the first bus with the single port. Redundancy is provided by allowing plural buses to selectively communicate with the single data port.

### BACKGROUND OF THE INVENTION

1. Field of the Invention

The present invention relates in general to the field of storage information handling systems, and more particularly to a method and system for selecting between serial storage buses to store data on a storage device using data signals of the buses.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One growing use for information handling systems is to store data and make the data available over a network. For instance, JBOD (Just a Bunch Of Disks), SAN (Storage Area Networks) and NAS (Network Attached Storage) information handling systems use a group of storage devices to store and make available information to other information handling systems over a network. Centralized storage generally offers greater convenience and speed in the use of information and greater flexibility to add storage as the need arises. However, redundant access to centralized storage is generally needed to provide a high level of availability to storage devices and to ensure that information is available in the event of system failures. Thus, storage information handling systems are typically accessible from at least two separate points in a network. For instance, Fibre Channel disk drives typically have a dual port interface with each port supporting a separate network loop for redundancy.

One difficulty that arises when arranging storage devices to have redundancy is that serial disk drives, such as disk drives that use the SATA and SAS protocols, typically only have a single port. In order to provide redundancy to such single port drives, a multiplexing device is typically used to switch between buses to interface the single port with redundant access points. For instance, the multiplexing device interfaces with two SCSI to SATA bridges with each bridge providing redundant access to the storage device through the multiplexing device. The bridges command the multiplexing device to provide access to the single port by sending a separate signal to switch the multiplexing device before the bridge sends information to the storage device. The separate switching command signal and wire increase the complexity of the operation of the storage device.

### SUMMARY OF THE INVENTION

Therefore a need has arisen for a method and system, which provides redundant access to a single port storage device with simplified selection of the access point to the storage device.

In accordance with the present invention, a method and system are provided which substantially reduce the disadvantages and problems associated with previous methods and systems for accessing a storage device having a single port. A signal detector detects a data storage signal from one of plural access points and uses the detection of the data storage signal to switch a multiplexing device to interface the single port with the access point that sent the data storage signal.

More specifically, a storage information handling system has plural SATA storage drives interfaced with first and second bridges through first and second buses. Each SATA storage drive has a single data port that communicates storage data between a selected bridge and the storage drive over the associated bus. A bus selector interfaces the single port of the SATA storage drive with the first and second buses through first and second bridge ports. Each bridge port interfaces with an associated signal detector and the two signal detectors interface with a multiplexing device. If a signal detector detects a data storage signal, such as an establish port command, the signal detector enables the multiplexing device to select the associated bridge port so that the data storage signal is interfaced with the single port. The inactive bridge port is precluded from accessing the multiplexing device until the data storage signal is complete and the signal detector disables the multiplexing device. In one embodiment, an arbitration module associated with each bridge coordinates contact attempts to storage devices to have one bridge send data storage signals at a time.

The present invention provides a number of important technical advantages. One example of an important technical advantage is that a multiplexing device switches between buses to allow access to a single port without sending a separate switching signal. The signal detector switches the multiplexing device when a valid storage signal is detected so that coordination of a separate switching signal is not necessary. Thus, single port storage devices are able to support redundant accesses to the single port from separate access points without separate coordination between the access points.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system for selectively communicating information from one of plural bridges based on a valid data storage signal; and

FIG. 2 depicts a block diagram of signal detectors that switching between ports based on receipt of a valid data storage signal.

### DETAILED DESCRIPTION

Redundancy in storage information handling systems, such as storage drives arranged as a JBOD, SAN or NAS, ensures that stored information is readily accessible even in the case of partial failures of systems. However, some storage devices, such as SATA storage drives, have only a single port to interface with multiple buses. A bus selector provided by the present invention supports redundancy with storage information handling systems that have only a single data port by using detection of valid data signals from one of plural buses to select which bus is multiplexed to interface with the data port. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

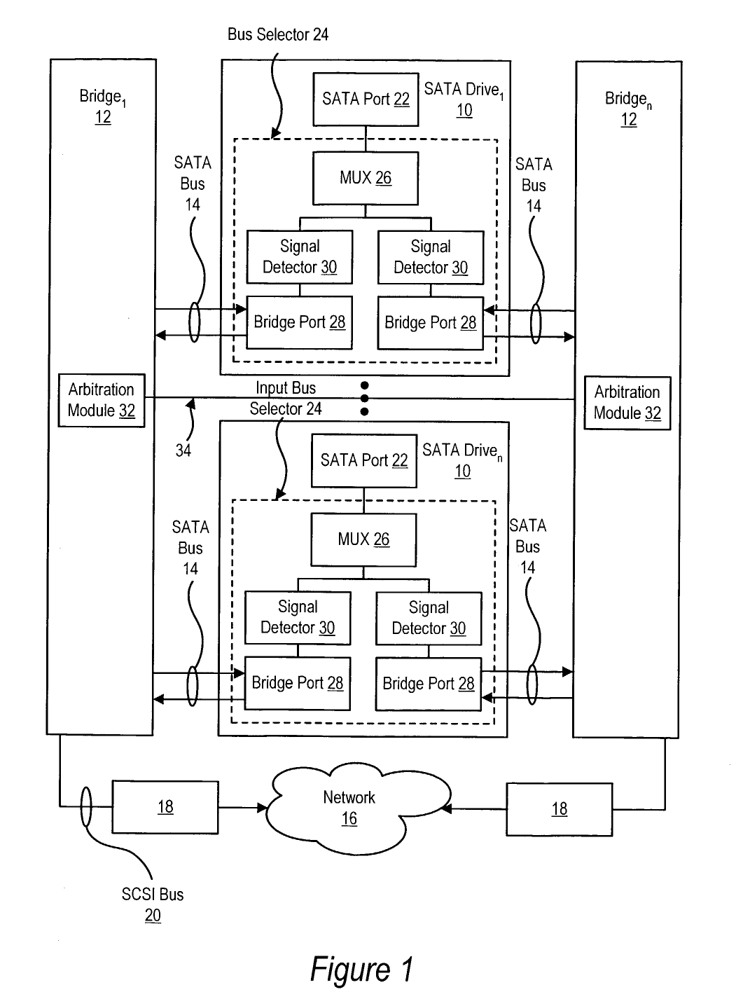

Referring now to FIG. 1, a block diagram depicts plural SATA storage drives 10 interfaced with plural bridge devices 12. Each bridge device 12 interfaces with storage drives 10 through SATA buses 14 and with networks 16 or information handling systems 18 through SCSI buses 20. Bridges 12 convert data received from storage drives 10 from the SATA protocol to the SCSI protocol in order to communicate the data over SCSI buses 20, and convert data received from SCSI bus 20 to the SATA protocol in order to communicate the data to storage devices 10. The use of multiple bridges 12 to communicate with each storage drive 10 through separate SATA buses 14 provides redundancy. For instance, if a bridge 12, bus 14, bus 20, network 16 or information handling system 18, then the other bridge 12 and bus 14 remain available to access a storage drive 10. Although FIG. 1 depicts the use of SATA and SCSI protocols, alternative embodiments may use alternative protocols. For instance, storage drives 10 may be arranged as a JBOD, SAN, NAS or other network attached storage device that communicates with a serial interface, such as SAS.

Each storage drive 10 has a single SATA port 22 through which the storage drive is able to communicate information. A bus selector 24 interfaces with SATA port 22 to allow the exchange of information through SATA port 22 from either of two SATA buses 14. A multiplexing device 26 allows access to SATA port 22 from either one of two bridge ports 28, thus allowing a selection of one of two bridges 12 to communicate with SATA drive 10. A signal detector 30 associated with each bridge port 28 monitors signals received at each bridge port 28 to determine if a valid SATA signal is received at the associated bridge port 28. If a valid SATA signal is detected by signal detector 30, then signal detector 30 directs multiplexing device 26 to select the bridge port 28 that is receiving the valid SATA signal so that the SATA signal is provided to SATA port 22. For instance, signal detector 30 monitors signals received at bridge port 28 to detect packets with header information that identifies the received packets as SATA packets, such as an “establish port” command. When a SATA packet is detected, signal detector 30 enables multiplexing device 26 to select the bridge port 28 at which the packet arrived. When multiplexing device 26 is selected to receive a SATA signal from one bridge port 28, it ignores requests received from the second bridge port 28. Once the SATA signal is complete, signal detector 30 disables multiplexing device 26 so that both bridge ports 28 are able to selectively receive a SATA signal.

Bus selector 24 supports bus redundancy with storage drives 10 that have only a single data port 22 by using data signals from the plural buses to select which bus is multiplexed to interface with data port 22. The use of a data signal detected by signal detector 30 to select a bus reduces coordination between bridges 12 in communicating with storage devices 10 since bridges 12 do not have to send a multiplexing device selection signal. Bus selector 24 is self-arbitrating in that selection of a bridge port 28 by multiplexing device 26 precludes the interfacing of data port 22 with any other bridge port until the selected bridge port 28 completes the sending of data. Attempts by another bridge 12 to communicate with data port 22 will fail until multiplexing device 26 is disabled by signal detector 30 to leave data port 22 open to accept another data signal or until the attempt times out.

In one embodiment, an arbitration module 32 associated with each bridge 12 coordinates communication by the bridges 12 to reduce simultaneous attempts by different bridges 12 to interface with the same storage device 10. For instance, a first arbitration module 32 associated with a first bridge sends an in-band signal, or an out-of-band signal by arbitration bus 34, to a second arbitration module 32 associated with a second bridge 12 when the first bridge starts and completes sending data to storage device 10. Arbitration module 34 prevents a bridge 12 from attempting to send data to a storage device 10 at the same time that another bridge 12 is sending data to the storage device 10. Arbitration modules 34 help to reduce unnecessary bus traffic by limiting attempts to send data when multiplexing device 26 has assigned port 22 to a bridge port 28. For instance, failed attempts to send data are reduced, as are false time outs that result if a port 22 in unavailable for an extended period of time.

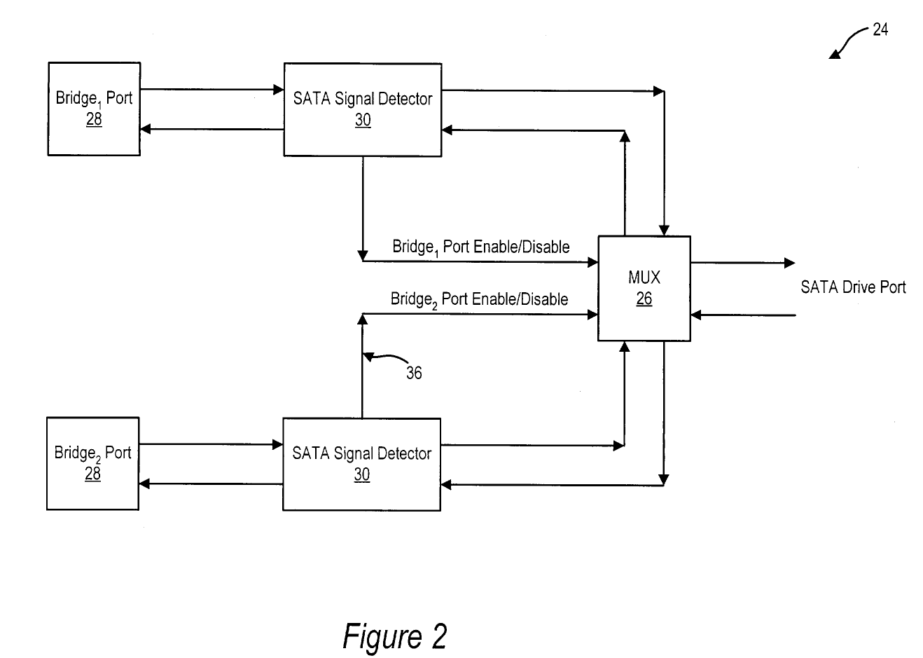

Referring now to FIG. 2, a block diagram depicts bus selector 24 for selectively interfacing a SATA storage device drive port with a first or second bridge. Each bridge communicates serial data through a bridge port 28 and a SATA signal detector 30. Each signal detector 30 communicates data to a multiplexing device 26, which selectively interfaces data from one of the bridge ports 28 to a SATA drive port. Multiplexing device 26 determines which of the bridge ports 28 to select based on a port selection line 36. If signal detector 30 detects a valid SATA signal associated with its bridge port, signal detector 30 enables port selection line 36 to direct multiplexing device 26 to select the associated bridge port 28 so that data signals sent through the selected bridge port are provided to the storage device port. While data is sent over the selected bridge port 28, multiplexing device 26 precludes data from being received from the other bridge port 28. When the sending of the data is complete, signal detector 30 disables port selection line 36 to free multiplexing device 26 to select either bridge port 28 at the next transfer data.

Although the present invention has been described in detail, it should be understood that various changes, substitutions and alterations could be made hereto without departing from the spirit and scope of the invention as defined by the appended claims.

What is claimed is:

1. A system for communicating with a SATA drive port through one of plural bridges, the system comprising:
a multiplexing device interfaced with the SATA drive port, the multiplexing device operable to select one of plural data signals to communicate with the SATA drive port;
a first bridge port operable to accept a SATA signal from a first bridge;
a second bridge port operable to accept a SATA signal from a second bridge;
a first signal detector interfaced with the multiplexing device and with the first bridge port, the first signal detector operable detect a SATA signal received from the first bridge and to direct the multiplexing device to select the first bridge port to communicate with the SATA drive port;
a second signal detector interfaced with the multiplexing device and with the second bridge port, the second signal detector operable detect a SATA signal received from the second bridge port and to direct the multiplexing device to select the second bridge port to communicate with the SATA drive port.

2. The system of claim 1 wherein the first and second signal detectors detect valid SATA signals by analyzing signal command information.

3. The system of claim 2 wherein the signal command information comprises an establish port command.

4. The system of claim 1 wherein the multiplexing device is further operable to prevent a non-selected bridge port from communicating with the SATA drive port.

5. The system of claim 1 further comprising an arbitration module associated with each bridge, the arbitration modules communicating with each other to preclude the bridges from simultaneously communicating data to the same SATA drive port.

6. The system of claim 5 wherein the arbitration modules are operable to communicate in-band.

7. The system of claim 5 wherein the arbitration modules are operable to communicate out of band.

8. A method for selecting one of plural buses to communicate a data signal with a storage drive, the storage drive having a single port, the method comprising:
interfacing a multiplexing device with the single port;
interfacing first and second buses with the multiplexing device;
monitoring the first and second buses to detect data signals;
detecting a data signal associated with the first bus; and
directing the multiplexing device to enable an interface of the first bus with the single port.

9. The method of claim 8 further comprising:
precluding the multiplexing device from enabling an interface of the second bus with the single port.

10. The method of claim 9 further comprising:
detecting the completion of the data signal associated with the first bus; and
directing the multiplexing device to disable the interface of the first bus with the single port and to allow the enabling of an interface of the second bus with the single port if a data signal associated with the second bus is detected.

11. The method of claim 8 wherein the single port comprises a serial protocol storage device port.

12. The method of claim 11 wherein the single port comprises a SATA protocol port.

13. The method of claim 11 wherein the single port comprises a Serial Attached SCSI protocol port.

14. The method of claim 8 further comprising:
interfacing the first and second buses with first and second bridges; and
arbitrating the bridges to preclude the sending of simultaneous data signals from the bridges to the multiplexing device.

15. The method of claim 8 wherein detecting a data signal further comprises detecting an establish port command.

16. The method of claim 8 wherein detecting a data signal further comprises detecting a SATA header value.

17. An information handling system comprising:
plural storage devices, each storage device having one data port;
plural bridges, each bridge interfaced to each storage device and operable to establish communication between each storage device and one or more external devices; and
a bus selector associated with each storage device data port, each bus selector operable to detect storage data signals from one of the bridges and to interface the bridge associated with the detected data signal with the data port.

18. The information handling system of claim 17 wherein the storage devices comprise SATA storage devices.

19. The information handling system of claim 18 wherein the bus selector detects an establish port command.

20. The information handling system of claim 17 further comprising an arbitration module associated with each bridge and operable to preclude simultaneous storage data signals to a storage device from plural bridges.
